(19) United States
(12) Patent Application Publication
(10) Pub. No.: US 2014/0258212 A1
(43) Pub. Date: Sep. 11, 2014

(54) DYNAMIC IN-MEMORY DATABASE SEARCH

(71) Applicants: Andreas Kunert, Wiesloch (DE); Klaus Kistner, Bad Mergentheim (DE)

(72) Inventors: Andreas Kunert, Wiesloch (DE); Klaus Kistner, Bad Mergentheim (DE)

(73) Assignee: SAP AG, Walldorf (DE)

(21) Appl. No.: 13/787,441

(22) Filed: Mar. 6, 2013

(51) Int. Cl. G06F 17/30

(52) U.S. Cl. CPC G06F 17/30377
USPC 707/607; 707/741

(57) ABSTRACT

The disclosure generally describes computer-implemented methods, software, and systems for providing an in-memory database search mechanism without using an index table. A system for accessing at least one of multiple data elements that are stored as non-key fields in one or more application tables comprises: an in-memory database storing the one or more application tables that store the multiple data elements as non-key fields, the system configured to execute operations comprising: receiving a criterion, retrieving, without using an index table, at least one data element of the one or more application tables that fulfills the criterion.

### TECHNICAL FIELD

The present disclosure relates to computer-implemented methods, software, and systems for providing an in-memory database search mechanism without using an index table.

### BACKGROUND

In a business application data model, data about a business application object is often distributed among conventional database tables. An application-dependent database view, or application view, may be defined by specifying a combination of database tables and/or fields. The defined application view allows the viewing of combined data applicable to the business application and is useful for various operations related to the business application data model, for example analytics.

In enterprise systems, there are OLTP (OnLine Transaction processing) systems used to carry out business processes of a company where employees and other stakeholders, such as suppliers or customers, follow a business process which may result in business documents created in a database of the OLTP system. In-memory databases thereby exploit recent innovations in hardware to run a database in main memory.

### SUMMARY

The present disclosure relates to computer-implemented methods, software, and systems for providing an in-memory database search mechanism without using an index table. Implementations of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

In one general aspect 1, a method, performed by a processor, for accessing at least one of multiple data elements that are stored as non-key fields or key fields in one or more application tables, wherein the one or more application tables are stored in an in-memory database, the method comprises: receiving a criterion, retrieving, without using an index table, at least one data element of the one or more application tables that fulfills the criterion.

In aspect 2 according to aspect 1, the in-memory database is a column-based in-memory database.

In aspect 3 according to any one of aspects 1 to 2, wherein the index table is a table comprising a copy of at least one of the multiple data elements without a dynamic link to corresponding location of the data element in the one or more application tables so that the copy of the data element does not change upon a change of the corresponding original data element in the one or more application tables.

In aspect 4 according to any one of aspects 1 to 3, wherein the multiple data elements are grouped into one or more data categories, and wherein the criterion defines a subset of the one or more data categories and a condition data elements corresponding to the subset have to fulfill. In an aspect, at least one mapping table (e.g., the in-memory database stores the at least one mapping table) comprises one or more fields that provide a mapping between each of the one or more data categories and one or more locations, within the one or more application tables, of the data elements that correspond to the respective data category, and wherein the retrieving of at least one data element of the one or more application tables that fulfills the criterion comprises: accessing the mapping table to determine, for at least one of the one or more application tables, at which location within the application table the at least one data element corresponding to the subset of data categories is stored. In an aspect, the retrieving of at least one data element of the one or more application tables that fulfills the criterion comprises: building and executing a Structured Query Language command comprising a static part encoding a first portion of the criterion and a dynamic part encoding a second portion of the criterion different from the first portion of the criterion, wherein the second portion comprises the condition.

In aspect 5 according to any one of aspects 1 to 4, further comprising: updating the mapping table upon augmenting at least one of the application tables by an additional data element stored as non-key field or key field at an additional location within the at least one of the application tables.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example system for providing a homogeneous data model based on in-memory database views.

FIG. 2 is a block diagram illustrating an enterprise server.

FIG. 3 is a block diagram illustrating a client.

FIG. 4 illustrates a conventional database system.

FIG. 5 illustrates a relationship between application tables and an index table.

FIG. 6 illustrates an in-memory database system without using an index table.

FIG. 7 illustrates an example interrelationship between application tables and a mapping table.

FIG. 8 illustrates an exemplary process for accessing or retrieving relevant data elements that are spread as non-key fields across multiple application tables.

FIG. 9 compares the conventional database using the index table with the in-memory database omitting the index table.

Reference numbers and designations in the various drawings indicate exemplary aspects, implementations or embodiments of particular features of the present disclosure

### DETAILED DESCRIPTION

This disclosure generally describes computer-implemented methods, software, and systems for providing an in-memory database search mechanism without using an index table. Specifically, this disclosure describes an in-memory database configured to access at least one data element of multiple data elements that are stored as non-key fields or key-fields in one or more application tables without using an index table, wherein the index table is a table comprising a copy of at least one of the multiple data elements without a dynamic link to corresponding location of the data element in the one or more application tables so that the copy of the data element does not change upon a change of the corresponding original data element in the one or more application tables.

The subject matter described in this specification can be implemented in particular implementations so as to realize one or more of the following advantages:

First, the amount of memory space needed is reduced by circumventing the use of the index table in which redundant data is normally stored.

Second, the database tables can be easily and quickly augmented making the database more flexible. Changes to the data can be easily incorporated and no complete rebuild of the tables and processes is required. The time required for updating or rebuilding the database tables is reduced.

Third, data stored as non-key fields in database tables can be directly and quickly accessed. Further, the data can be accessed on-demand.

Fourth, all tables and processes can be embedded in an in-memory database reducing the runtime.

Fifth, less database maintenance is required as the index table is omitted.

The described approach can be applied to various types of data such as financial statistical data, bonus relevant invoices, credit examination data, machine status data, simulation data or product purchasing data. Other advantages will be apparent to those skilled in the art.

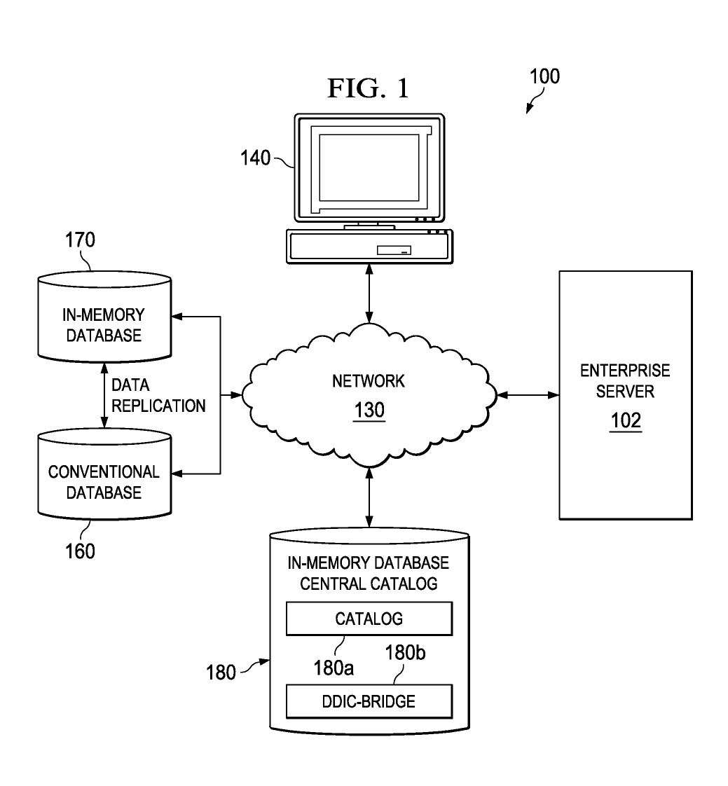

FIG. 1 illustrates an example distributed computing system 100 operable to provide a homogeneous data model based on in-memory database views. Specifically, the illustrated example distributed computing system 100 includes or is communicably coupled with a enterprise server 102, a client 140, and a conventional database 160, an in-memory database 170, and an in-memory database central catalog 180 that communicate across a network 130. At a high level, the enterprise server 102 provides business application or other services in an organization's system landscape. Generally, through a graphical user interface (GUI), a user, for example a client 140 is provided with an efficient and user-friendly presentation of data provided by or communicated within the example distributed computing system 100 and the ability to perform operations within the example distributed computing system 100.

In some implementations, the in-memory database 170 is used as a primary database to the enterprise server 102. In this implementation, the client 140 interfaces with the in-memory database 170 and with the in-memory database central catalog 180. This implementation allows for the direct analytical access to the data stored in the enterprise server using analytical tools working with the in-memory database 170. In other implementations, the in-memory database 170 is used as a secondary database side-by-side or in combination with a conventional database 160 that interfaces with the enterprise server 102. In this implementation, the client 140 interfaces with the conventional database 160, the in-memory database 170, and the in-memory database central catalog 180. The data needed for analytical operations is replicated in real-time or near real-time to the in-memory database 170. The analytical applications are executed against the in-memory database 170 and the existing data for the enterprise server 102 on the conventional database 160 is not affected. As will be appreciated to those skilled in the art, other configurations of the enterprise server 102, client 140, conventional database 160, in-memory database 170, and in-memory database central catalog 180 are possible without departing from the scope of this disclosure.

The example distributed computing system 100 includes a conventional database 160 containing data applicable to, in some implementations, a business application (described below) associated with the enterprise server 102. The conventional database 160 primarily relies on non-volatile magnetic, optical, removable, or other suitable non-electronic memory, for storage, retrieval, and processing of data. Although illustrated as a stand-alone component of the example distributed computing system 100, conventional database 160 may be integrated wholly or in part with any other component of the example distributed computing system 100. The conventional database 160 may also take the form of a physical and/or virtual database.

The example distributed computing system 100 also includes an in-memory database 170. The in-memory database 170 is a high-performance database management system (DBMS) that primarily relies on volatile electronic memory, such as random access memory (RAM), as opposed to magnetic, optical, removable, or other suitable non-electronic memory, for storage, retrieval, and processing of data. The reliance on electronic memory allows, in some implementations, for near-real-time aggregation, replication, synchronization, and processing of data. In some implementations, a persistency layer ensures that a copy of the in-memory database is maintained on non-volatile magnetic, optical, removable, or other suitable non-electronic memory in the event of a power or other system failure in order to allow recovery of the in-memory database. In some implementations, the in-memory database 170 can be replicated to the conventional database 160 for backup purposes. In some implementations, data from the conventional database 160 can be replicated to and used from the in-memory database.

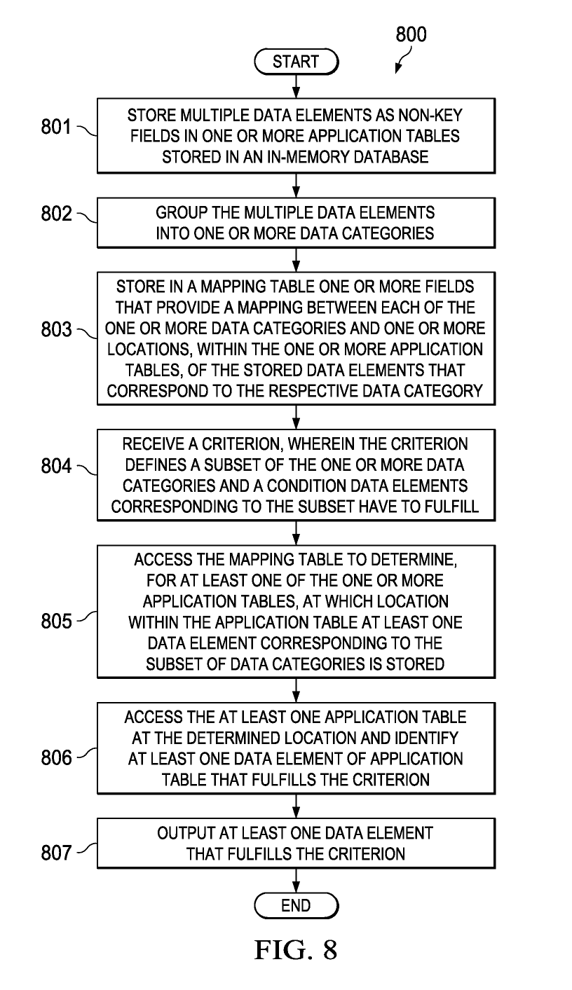

In FIG. 1, the example distributed computing system 100 includes an in-memory database central catalog (DCC) 180. In some implementations, the DCC 180 contains a catalog 180a database table and a data dictionary (DDIC)-bridge 180b database table. In other implementations, the catalog 180a and the DDIC-bridge 180b are combined. In some implementations, there is a only single DCC 180 in the example distributed computing system 100 communicably coupled to other components of the example distributed computing system 100 using network 130. The catalog 180a contains application view fields and ensures consistent and reusable naming for the application view fields. For example, a catalog 180a application view field entry for “EmployeeID” may be used in multiple application views to refer to the same application view field name as well as being easy understandable. In some implementations, entries in the catalog 180a and/or the DDIC-bridge 180b can be created, modified, and/or deleted by experts with a semantic understanding of a business application. These entries can then be appropriately used by the method described in FIG. 8 below.

The DDIC-bridge 180b links all entries in the catalog, for example “EmployeeID” to actual database entities, for example an “EmpID” database column name. The DDIC-bridge 180b may contain, among other data values, links to database domains, data elements, and/or database table fields available on the in-memory database 170. The DDIC-bridge 180b provides data necessary to ensure non-duplicative naming of all application view field names.

A view field naming application/service (described below) is provided to analyze the underlying database entity characteristics that an application view field is based on, the catalog 180a, and the DDIC-bridge 180b data values associated with particular catalog 180a entries to propose an external name to use with the application view field. For example, assuming a database table with a column name of “Pers” that is known to contain the last name of a person, it is necessary to check whether an entry in the catalog 180a already is mapped to this actual column name. At a high-level, it is difficult without actual knowledge to know how to search the catalog 180a to determine whether there is already an appropriate entry for this column name. For example, a catalog 180a entry for “Person” may not represent the last name of a person, but instead an identification number issued by the country of residence.

As application view field names in the catalog 180a are typically derived from corresponding database table field names, this relationship between the catalog 180a entry and the actual database table field name provides a link, the DDIC-bridge 180b, between the catalog 180a entry and the underlying database domains, data elements, and/or database table fields.

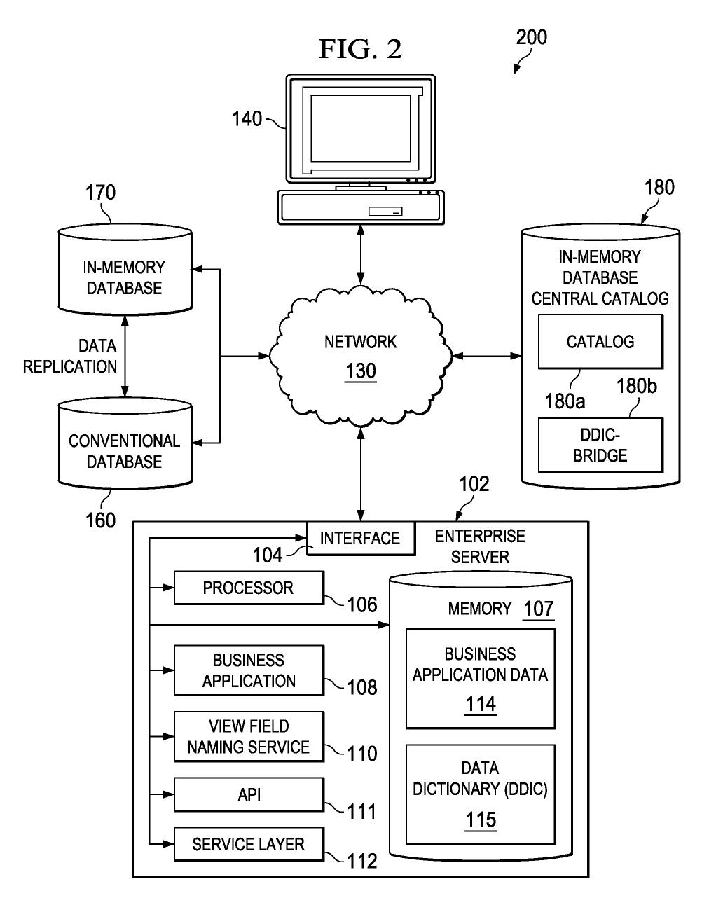

Turning now to FIG. 2, FIG. 2 is a block diagram 200 illustrating an enterprise server 102. At a high level, the enterprise server 102 comprises an electronic computing device operable to receive, transmit, process, store, or manage data and information associated with the example distributed computing system 100. For example, the enterprise server can be part of an enterprise resource planning (ERP) or a customer relationship management (CRM) system. In general, in-memory databases utilize recent innovations in hardware to run an entire database in main memory. In an aspect, in-memory database may be used as sole analytical system, where full aggregation capabilities and columnar storage capabilities of in-memory data processing may be utilized to provide ultrafast analytics to analyze huge volumes of data in extremely short time frames in order to enable real-time decision making. In a general aspect, in-memory database may be used as underlying database for other systems (e.g., OnLine Analytical Processing, OLAP) systems to speed up data access and aggregations. In a general aspect, in-memory database may be used as secondary database of an OLTP system to speed up intensive operations in OLTP.

In general, the enterprise server 102 is a server that stores a business application 108 and a central catalog service 110, where at least a portion of the business application 108 and/or the central catalog service 110 is executed using requests and responses sent from/to a client 140 within and communicably coupled to the illustrated example distributed computing system 100 using network 130. In some implementations, the enterprise server 102 may store a plurality of various business applications 108. In other implementations, the enterprise server 102 may be a dedicated server meant to store and execute only a single business application 108. In some implementations, the enterprise server 102 may comprise a web server, where the business application 108 and/or central catalog service 110 represents one or more web-based applications accessed and executed by the client 140 using the network 130 or directly at the enterprise server 102 to perform the programmed tasks or operations of the business application 108 and/or the central catalog service 110.

Specifically, the enterprise server 102 is responsible for receiving application requests, for example business application 108 and/or central catalog service 110 requests, from one or more client applications associated with the client 140 of the example distributed computing system 100 and responding to the received requests by processing said requests in the associated business application 108 and/or central catalog service 110, and sending an appropriate response from the business application 108 and/or central catalog service 110 back to the requesting client application. In addition to requests from the client 140, requests associated with the business application 108 and/or central catalog service 110 may also be sent from internal users, external or third-party customers, other automated applications, as well as any other appropriate entities, individuals, systems, or computers. According to one implementation, enterprise server 102 may also include or be communicably coupled with an e-mail server, a web server, a caching server, a streaming data server, and/or other suitable server. In other implementations, the enterprise server 102 and related functionality may be provided in a cloud-computing environment.

As illustrated in FIG. 1, the enterprise server 102 includes an interface 104. Although illustrated as a single interface 104 in FIG. 1, two or more interfaces 104 may be used according to particular needs, desires, or particular implementations of the example distributed computing system 100. The interface 104 is used by the enterprise server 102 for communicating with other systems in a distributed environment—including within the example distributed computing system 100—connected to the network 130; for example, the client 140, the conventional database 160, the in-memory database 170, and/or the DCC 180, as well as other possible systems/components that may be communicably coupled to the network 130 (not illustrated). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated example distributed computing system 100.

As illustrated in FIG. 1, the enterprise server 102 includes a processor 106. Although illustrated as a single processor 106 in FIG. 1, two or more processors may be used according to particular needs, desires, or particular implementations of the example distributed computing system 100. Generally, the processor 106 executes instructions and manipulates data to perform the operations of the enterprise server 102. Specifically, the processor 106 executes the functionality required to receive and respond to requests from, for example, the client 140 and/or other possible systems/components that may be communicably coupled to the network 130 (not illustrated), and to execute the business application 108 and/or central catalog service 110 functionality.

The enterprise server 102 also includes a memory 107 that holds data for the enterprise server 102. Although illustrated as a single memory 107 in FIG. 1, two or more memories may be used according to particular needs, desires, or particular implementations of the example distributed computing system 100. While memory 107 is illustrated as an integral component of the enterprise server 102, in alternative implementations, memory 107 can be external to the enterprise server 102 and/or the example distributed computing system 100.

The memory 107 holds data for the enterprise server 102. In some implementations, the memory 107 includes business application data 114 and a data dictionary (DDIC) 115. Although illustrated as single instances, there may be more than one instance of the business application data 114 and the DDIC 115.

The data dictionary 115 is a central, non-redundant, logical description/definition of all data objects used within systems/components of example distributed computing system 100, for example, the conventional database 160 and/or the in-memory database 170. Example data objects stored within the data dictionary 115 includes, for example, domains, data elements, and/or database table fields. For example, the data dictionary 115 shows how the data objects are mapped to an underlying relational database in tables or views which store business application data 114. New or modified data objects within the data dictionary 115 are available to all components associated with the systems/components of example distributed computing system 100. The data dictionary 115 also provides standard editing functions for editing data objects within the data dictionary 115. Although illustrated as stored on enterprise server 102, in other implementations, the DDIC 115 may be wholly or partially stored on the conventional database 160, the in-memory database 170, and/or the client 140.

At least one business application 108 is illustrated within the enterprise server 102. The business application 108 can be any application, program, module, process, or other software that may execute, change, delete, generate, or otherwise manage information associated with a particular enterprise server 102, and in some cases, a business process performing and executing business process-related events. In particular, business processes communicate with other users, applications, systems, and components to send and receive events. In some implementations, a particular business application 108 can operate in response to and in connection with at least one request received from an associated client 140. Additionally, a particular business application 108 may operate in response to and in connection with at least one request received from other business applications 108, including a business application 108 associated with another enterprise server 102 (not illustrated). In some implementations, each business application 108 can represent a Web-based application accessed and executed by remote clients 140 via the network 130 (e.g., through the Internet, or via at least one cloud-based service associated with the business application 108). For example, a portion of a particular business application 108 may be a Web service associated with the business application 108 that is remotely called, while another portion of the business application 108 may be an interface object or agent bundled for processing at a remote client 140. Moreover, any or all of a particular business application 108 may be a child or sub-module of another software module or enterprise application (not illustrated) without departing from the scope of this disclosure. Still further, portions of the particular business application 108 may be executed or accessed by a user working directly at the enterprise server 102, as well as remotely at a corresponding client 140. In some implementations, the enterprise server 102 can execute the business application 108.

Business application data 114 is any type of data associated with a data object used by the business application 108. For example, for a business application 108 that processes sales invoices, business application data 114 for a specific sales invoice data object may include data pertaining to a particular sales invoice number, buyer, seller, date, address, product(s), quantity, price, tax rate, etc. Although illustrated as stored on enterprise server 102, in other implementations, the business application data 114 may be wholly or partially stored on the conventional database 160, the in-memory database 170, and/or the client 140.

The service layer 112 provides software services to the enterprise server 102 and the example distributed computing system 100. The functionality of the enterprise server 102 may be accessible for all service consumers via this service layer. Software services, such as a central catalog service 110 (described below), provide reusable, defined business functionalities through a defined service interface. For example, the service interface may be software written in extensible markup language (XML) or other suitable language. While illustrated as an integrated component of the enterprise server 102 in the example distributed computing system 100, alternative implementations may illustrate the service layer 112 as a stand-alone component in relation to other components of the example distributed computing system 100. Moreover, any or all parts of the service layer 112 may be implemented as child or sub-modules of another software module or enterprise application (not illustrated) or of another hardware module (not illustrated) without departing from the scope of this disclosure.

The enterprise server 102 further includes a view field naming service 110. The view field naming service 110 is responsible for proposing names for an application view field. In some implementations, the view field naming service 110 interfaces with the service layer 112 to provide naming functionality to a service consumer, for example a client 140. In some implementations, the view field naming service 110 is made available to the client 140 by means of a plug-in, add-in, or other software. In some implementations, the view field naming service 110 runs continuously. In other implementations, the view field naming service 110 is triggered. For example, the view field naming service 110 could be triggered by a request received from the client application 146 through the service layer 112. In some implementations, view field naming service 110 communicates with the catalog 180a, the DDIC-bridge 180b, and the data dictionary 115.

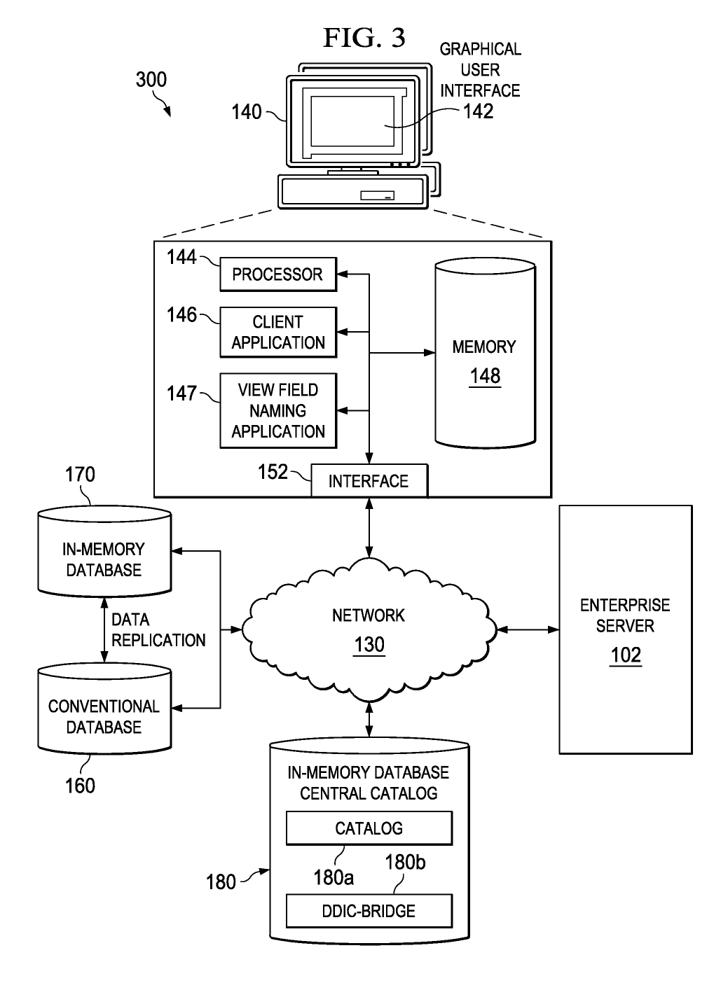

Turning now to FIG. 3, FIG. 3 is a block diagram 300 illustrating a client 140. The client 140 may be any computing device operable to connect to or communicate with at least the enterprise server 102 using the network 130. In general, the client 140 comprises an electronic computer device operable to receive, transmit, process, and store any appropriate data associated with the example distributed computing system 100.

The illustrated client 140 further includes a client application 146. The client application 146 is any type of application that allows the client 140 to request and view content on the client 140. In some implementations, the client application 146 can be and/or include a web browser. In some implementations, the client-application 146 can use parameters, metadata, and other information received at launch to access a particular set of data from the enterprise server 102. Once a particular client application 146 is launched, a user may interactively process a task, event, or other information associated with the business suite server 102. Further, although illustrated as a single client application 146, the client application 146 may be implemented as multiple client applications in the client 140.

In some implementations, the client application 146 can serve as a frontend modeling and administration GUI application for the in-memory database 170. The client application 146 functionality may provide, for example, load control and replication server/job management, loading of data from third-party database systems, manage connections to one or more enterprise servers 102, data model and business object modeling, and other suitable tasks applicable to the in-memory database 170. In some implementations, a connection to the in-memory database central catalog 180 is configured with a configuration setting in the client application 146.

The illustrated client 140 further includes a view field naming application 147. The view field naming application 147, similar to the view field naming service 110 described above, is responsible for proposing names for an application view field. In some implementations, the view field naming application 147 interfaces with the client application 146. The interface between the view field naming application 147 and the client application 146 may be facilitated by means of a plug-in, add-in, or other software. In some implementations, the view field naming application 147 runs continuously. In other implementations, the view field naming application 147 can be triggered. For example, the client application 146 could trigger the view field naming service 147 using a request. In some implementations, view field naming application 147 communicates with the catalog 180a, the DDIC-bridge 180b, and the data dictionary 115.

The illustrated client 140 further includes an interface 152, a processor 144, and a memory 148. The interface 152 is used by the client 140 for communicating with other systems in a distributed environment—including within the example distributed computing system 100—connected to the network 130; for example, the enterprise server 102, the conventional database 160, the in-memory database 170, and/or the DCC 180, as well as other possible systems/components that may be communicably coupled to the network 130 (not illustrated). The interface 152 may also be consistent with the above-described interface 104 of the enterprise server 102. The processor 144 may be consistent with the above-described processor 106 of the enterprise server 102. Specifically, the processor 144 executes instructions and manipulates data to perform the operations of the client 140, including the functionality required to send requests to the enterprise server 102, the conventional database 160, the in-memory database 170, and/or the DCC 180, as well as other systems/components communicably coupled to the network 130 (not illustrated) and to receive and process responses from the enterprise server 102, the conventional database 160, the in-memory database 170, and/or the DCC 180, as well as other possible systems/components that may be communicably coupled to the network 130 (not illustrated). The memory 148 may be consistent with the above-described memory 107 of the enterprise server 102. Specifically the memory 148 stores objects and/or data associated with the purposes of the client 140.

Further, the illustrated client 140 includes a GUI 142. The GUI 142 interfaces with at least a portion of the example distributed computing system 100 for any suitable purpose, including generating a visual representation of a web browser. In particular, the GUI 142 may be used to view and navigate various web pages located both internally and externally to the enterprise server 102, the conventional database 160, the in-memory database 170, and/or the DCC 180, as well as other systems/components communicably coupled to the network 130 (not illustrated).

There may be any number of clients 140 associated with, or external to, the example distributed computing system 100. For example, while the illustrated example distributed computing system 100 includes one client 140, alternative implementations of the example distributed computing system 100 may include multiple clients 140 communicably coupled to the enterprise server 102, the conventional database 160, the in-memory database 170, and/or the DCC 180, as well as other possible systems/components that may be communicably coupled to the network 130 (not illustrated), or any other number suitable to the purposes of the example distributed computing system 100. Additionally, there may also be one or more additional clients 140 external to the illustrated portion of the example distributed computing system 100 that are capable of interacting with the example distributed computing system 100 using the network 130. Further, the term “client” and “user” may be used interchangeably as appropriate without departing from the scope of this disclosure. Moreover, this disclosure contemplates that one or many users may use one computer, or that one user may use multiple computers.

The illustrated client 140 is intended to encompass any computing device such as a workstation, desktop computer, laptop/notebook computer, wireless data port, smart phone, personal data assistant (PDA), tablet computing device, one or more processors within these devices, or any other suitable processing device. For example, the client 140 may comprise a computer that includes an input device, such as a keypad, touch screen, or other device that can accept user information, and an output device that conveys information associated with the operation of the business suite server 102 or the client 140 itself, including digital data, visual information, or a GUI 142, as shown with respect to the client 140.

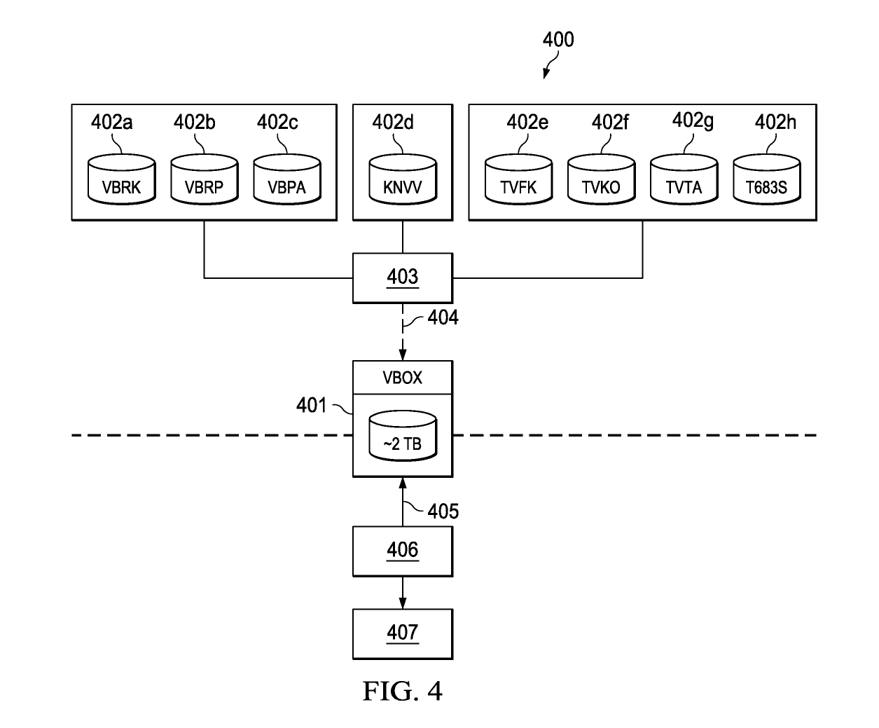

Turning now to FIG. 4. FIG. 4 illustrates a conventional database system 400. It usually comprises application tables 402a-h, a so-called index table 401 and multiple operational steps 403, 404, 405, 406. Data stored in the application tables 402a-h (e.g., invoices, status data of machines, credit statistics, bonus relevant data etc.) is usually redundantly stored in the index table 401 in the conventional database system 400. This may be done by preparing 403 the native data and writing 404 the prepared data to the index table 401. This conventional approach may lead to huge amounts of redundant data copied and stored in the index table 401. For example, if one wants to determine which customer is relevant to receive a bonus, one needs to identify the invoices that fulfill a certain predetermined criterion for the bonus. However, the native data is usually stored in non-key fields.

In an aspect, “key fields” may point to related tables, e.g. key fields may connect two or more tables. For example, two key fields may connect two tables. A “non-key field” may be a field in a table that does not connect to another table by a dynamic connection. A “dynamic connection” provides a change in a key-field of one of the two connected tables to occur, upon the key-field in the other of the two connected tables is changed. A dynamic connection between two different fields, each located in one of two different tables, ensures that a change to one of the fields is experienced by both fields and thus also by both tables. A key field may reference to the current content of another key field, e.g. in another table. In an aspect, the key-fields may be entries in the application tables that are configured to connect two or more tables, e.g. tables among the application tables. In an aspect, the key-fields may be one or more entries in the application table that are configured to point to, and/or define the relationship with, another application table. In an aspect key-fields may be a part of the metadata and may identify if there are any key or non-key relationships between any two or more application tables. In an aspect, the metadata contained in the application tables may indicate a type of a table, e.g. that a table among the application tables represents a master table or a transactional table within the application tables in the database.

As stated above, the native data is usually stored in non-key fields and/or key-fields within the application tables 402a-h. For example, the invoice may be a scanned version of a paper invoice and the relevant data may just be placed in a field of the application table without any link to another field. For this reason, a determination of the relevant data, e.g. for the determination of the bonus-relevant data, various combinations of data from the application tables 402a-h is usually copied 404 to the index table 401. For example, one may define a filter 403 which determines which combinations of data may be copied or written 404 to the index table. The pre-selected number of combinations of data (e.g., data of birth, date of payment, date of purchase, product material, number of items purchased etc.) is then copied 404 from the application tables 402a-h to the index table 401 so that later on one may be able to identify the relevant data which fulfills a predetermined criterion (e.g., date of birth=Jan. 12, 1984; product material=copper). In the conventional database 400 (e.g., using the index table 401), one so far had to rebuild the whole index table 401 if a change in the data of the application tables 402a-h or a change in the criterion for the determination of relevant data occurs. However such a rebuild usually may take hours or even days as the memory space required for the index table 401 may be up to 2 terabyte. It may happen that the memory space required for the index table 401 is larger than for the native data in the application tables 402a-h due to the large number of data combinations that are stored on spec in the index table 401. This may lead to significant off times (e.g., in the range of weeks) for a company and may affect multiple or even all operational divisions of the company that rely on the actuality and relevance of the data stored in the index table 401. If one uses the conventional database technology using the index table, one may be inherently stuck in a trade-off: on the one hand, a large index table may reduce the risk of a rebuild but once a rebuild has to be performed it may take a long time (e.g., weeks) until the system is back up and running. On the other hand, a small index table may reduce the time needed for a rebuild but may increase the risk for rebuilds to be necessary in view of changes to the data stored in the application tables.

After such a complete rebuild of the index table 401, all decisions made based upon the data stored in the index table need to be performed again, since the data basis for the calculation could have been changed. This may lead to additional runtime during which the decision makers do not have valid or updated data. The rebuilt data needs again to be read 405 to determine 406 relevant data and application tables, and the result needs to be outputted 407 to the decision makers.

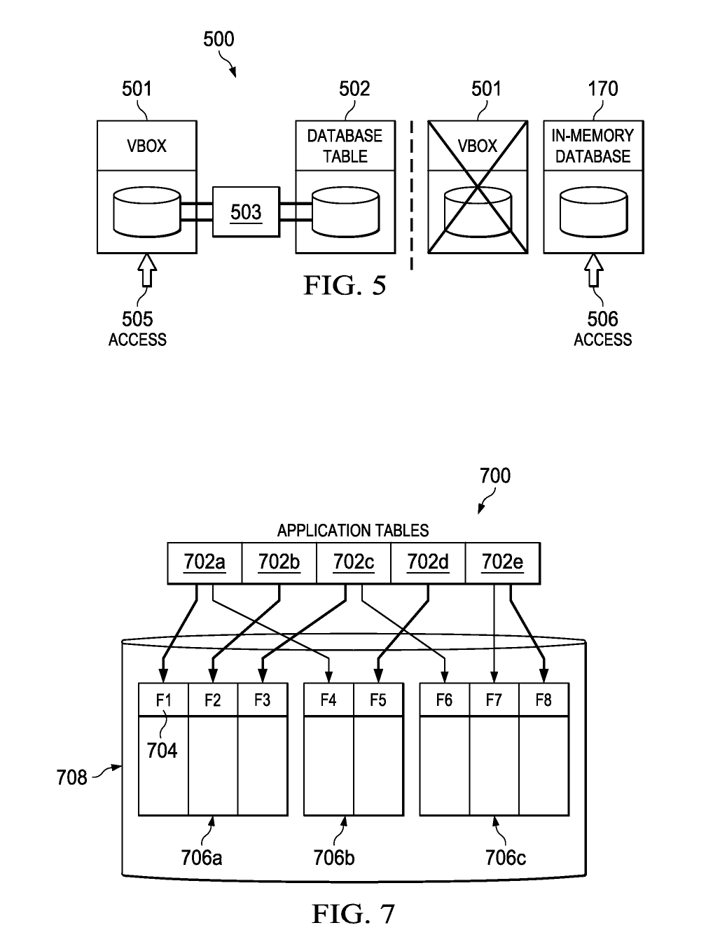

Turning now to FIG. 5. FIG. 5 illustrates the relationship between the application tables 502 and the index table 501. The conventional database 400 using the index table 401, 501 to read 405 data initially stored as non-key fields in application tables 402a-h, 502 shows the inherent disadvantage that due to the large amounts of native data spread across multiple application tables, a direct access of the native data stored in the application tables 502 is not feasible due to the long runtime required. If the native data is stored as non-key fields, no direct access is possible with a conventional database in a reasonable time. For this reason the index table 501 is usually created to store a certain number of combinations of data from the application tables 502 that could be of interest later on. This may lead to a data redundancy 503 between the application tables 502 and the index table 501. For example, one may want to derive a value or a decision from the data from the application tables 502 during an analysis of a business process. The index table 501 may allow an access 505 to the data stored in the index table 501, wherein the data is a copy of the native data in the application tables 502. However, the index table needs to be completely rebuilt upon a change occurring in the native data in the application tables 502, as the index table does not have any commemoration where its copied data originally came from within the application tables 502. Thus a change occurring in the native data of the application tables 502 does not trigger a corresponding change of the corresponding copied data in the index table 401 to occur. The index table 501 therefore inherently tends to be out-dated. The present application therefore aims for circumventing the index table 501 by embedding the application tables 502 and the data processing steps 405, 406, 407 in the in-memory database 170 according to FIGS. 1-3 while directly accessing 506 the non-key fields or key-fields of the application tables 402a-h, 502. This may circumvent the need for redundantly producing huge amounts of data with its inherent disadvantage of off times during rebuild/updating.

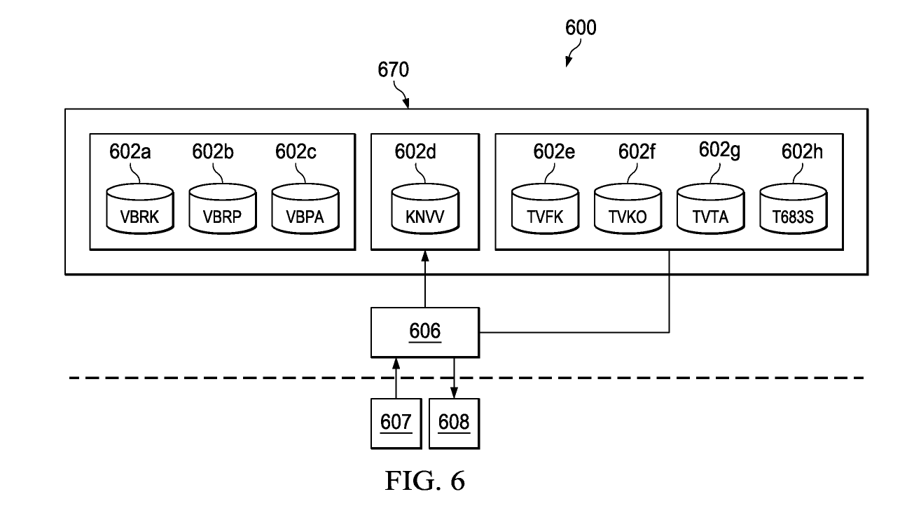

Turning now to FIG. 6. FIG. 6 illustrates an in-memory database system 600 without using an index table. The system is configured for accessing 506, 606 at least one of multiple data elements that are stored as non-key fields or key fields in one or more application tables 602a-h and comprises: an in-memory database 170, 670 storing the one or more application tables that store the multiple data elements as non-key fields; the system 600 configured to execute operations comprising: receiving a criterion 607; retrieving 606, without using an index table, at least one data element of the one or more application tables 602a-h that fulfills the criterion 607. In an aspect, the retrieved least one data element of the one or more application tables 602a-h that fulfills the criterion 607 is outputted 608. The term “index table” may be understood to be a table comprising a copy of at least one of the multiple data elements without a dynamic link to corresponding location of the data element in the one or more application tables so that the copy of the data element does not change upon a change of the corresponding original data element in the one or more application tables. In an aspect, the “index table” may comprise combinations of data elements of the one or more application tables without memorizing at which location the data elements are located in the one or more application tables.

In an implementation, the system 600 may be part of an online transaction processing (OLTP) system or of an enterprise resource planning (ERP) system, wherein the one or more application tables may originate from the OLTP system or the ERP system. In an aspect, the data stored as non-key fields or key fields in the application tables 602a-h may be data originating from or processed by the OLTP system or the ERP system.

In an aspect, the in-memory database 170, 670 may be a column-based in-memory database. In an aspect, the data stored in the application tables 602a-h may be stored in columns of the tables 602a-h. In an aspect, the non-key field of a table may be a field that does not connect to a field (e.g., another key field) of another table.

In an aspect, the multiple data elements may be grouped into one or more data categories 706a-c, and wherein the criterion 607 defines a subset of the one or more data categories 706a-c and a condition data elements corresponding to the subset have to fulfill.

Turning now to FIG. 7 with continued reference to FIG. 6, FIG. 7 is an illustrated an example interrelationship between application tables 702a-e and a mapping table 708. In an aspect, the mapping table 708 may comprise one or more fields 704 (e.g., fields F1, F2, F3, F4, F5, F6, F7, and F8) that provide a mapping between each of the one or more data categories 706a-c and one or more locations, within the one or more application tables 602a-h, 702a-e, of the data elements that correspond to the respective data category 706a-c. In an aspect, the mapping may be performed automatically or manually by a user (e.g., customer or administrator). In an aspect, the in-memory database 170, 670 (e.g., the in-memory database according to FIGS. 1-3, 6) may store the mapping table 708, or the mapping table 708 may be stored in a convention database memory as a part of a side-by-side database architecture. In an aspect, the mapping table 708 has a commemoration at which location within the system (e.g., at which location within the application tables) data corresponding to certain data categories may be found. In an aspect, the retrieving 606 of at least one data element of the one or more application tables 602a-h that fulfills the criterion may comprise: accessing 606 the mapping table 708 to determine 606, for at least one of the one or more application tables 602a-h, at which location within the application table 602a-h the at least one data element corresponding to the subset of data categories 706a-c is stored. In an aspect, the mapping table 708 may not comprise the data elements of the one or more application tables 602a-h, 702a-e, and wherein the mapping table 708 may be configured to update its fields upon augmenting at least one of the application tables by an additional data element stored as non-key field or key field at an additional location within the at least one of the application tables 602a-h, 702a-e. In an aspect, the updating of the mapping table 708 may be performed by a user (e.g., customer or administrator).

The application tables 702a-e are made up of specified fields, for example key fields and non-key fields, that contain one or more data elements, such as product number, date of sale, birthday of customer, amount paid or material condition of the sold product. The application tables 702a-e allow the viewing of combined fields (and associated data) applicable to the business application. In an aspect, an in-memory database 170, 607 according to FIGS. 1-3, 6 stores the one or more application tables 602a-h, 702a-e that store multiple data elements as non-key fields or key-fields, wherein the multiple data elements are grouped into one or more data categories 706a-c. In an aspect, the mapping table 708 may be configured to update upon augmenting at least one of the application tables 602a-h, 702a-e by an additional data element stored as non-key field (or as a key-field) at an additional location within the at least one of the application tables 602a-h, 702a-e. For example, if one adds an additional field for a data element to an application table 602a-h, 702a-e, then the location of this additional field will be added to the mapping table 708 and will be associated to a data category 706a-c to which the data element in the additional field belongs to. For example, an additional data element may be added to an existing field in an application table, but its data category 706a-c may be different from the data elements already existing in the field of the table 602a-h, 702a-e. This may lead to an automatic update of the mapping table 708 in that the location of the field is now referenced to the two respective data categories 706a-c. In an aspect, the updating or rebuild of the mapping table 708 does only require a few minutes of time as the amount of data stored in the mapping table is negligible compared to the amount of data stored in the application tables 602a-h, 702a-e. In an aspect, the mapping table 708 may not comprise the data elements of the one or more application tables 602a-h, 702a-e, but may only comprise the one or more categories 706a-c and the respective locations of the data elements that correspond to the categories 706a-c. In an aspect, the mapping table 708 may provide information based upon which one can find data elements in the application tables 602a-h, 702a-e, which belong to the categories 706a-c included in the mapping table 708, and the location of these data elements is listed along with the respective categories 706a-c in the mapping table 708. For example the fields 704 may comprise fields for various locations of data elements that belong to the respective categories 706a-c.

In an implementation, the mapping table 708 may use varying Structured Query Language (SQL) logic to access the data. The SQL-based selection logic may be applied to the application tables without using an index table. The SQL selection logic may define which data categories may be desired and the location in the application tables at which such data corresponding to the respective data categories can be found. In an aspect, the retrieving of at least one data element of the one or more application tables that fulfills the criterion comprises: building and executing a Structured Query Language command comprising a static part encoding a first portion of the criterion and a dynamic part encoding a second portion of the criterion different from the first portion of the criterion, wherein the second portion comprises the condition.

In most cases the field content is filled from one origin (application table field), but in other cases a more complex selection logic is executed. To determine the invoice this logic needs to be reversed. Essentially, an extension of the logic is provided to determine the desired data element in the application data by referencing one or more locations, independent from the data in the application tables, by a freely defined extension of a SQL query. To enable this, the mapping functions are offered. One or more of the following exemplary mapping functions are available alone or in combination to map fields in the mapping table to locations in the original application table:
Function ‘0’: the field in the mapping table is mapped 1:1 to one original application table
Function ‘1’: the field can be filled from either of two application tables
Function ‘2’: the field has to be ignored during invoice determination. An example field for this function is the campaign id. If the campaign is created after the invoice, the invoice should still be found according to the remaining selection criteria.
Function ‘3’: the field is not persisted on the database. The field is ignored during invoice selection. For the determined invoices an additional pricing check is executed to determine the rebate relevance. This function can be very performance intensive and should be avoided if possible.
Function ‘4’: the field is a hierarchy partner field. Access is done on partner table using the hierarchy level (derived from the field name).
Function ‘5’: the field is a product hierarchy field.
Function ‘6’: an additional condition can be defined for the field. The table is joined on document number field to table VBRK. Can be used e.g. for partner roles in table VBPA.
Function ‘7’: complex logic implemented by BADi. The BADi function allows programming the relation between a field in the mapping table and the application tables. The customer may enter a customized function.

Turning now to FIG. 8. FIG. illustrates an exemplary process or method 800 for accessing or retrieving relevant data elements that are spread as non-key fields or key fields across multiple application tables 602a-h, 702a-e. After the process 800 starts, multiple data elements are stored at step 801 as non-key fields in one or more application tables that are stored in an in-memory database.

At step 802, group the multiple data elements into one or more data categories.

At step 803, store in a mapping table one or more fields that provide a mapping between each of the one or more data categories and one or more locations, within the one or more application tables, of the stored data elements that correspond to the respective data category.

At step 804, receive a criterion, wherein the criterion defines a subset of the one or more data categories and a condition data elements corresponding to the subset have to fulfill.

At step, 805, access the mapping table to determine, for at least one of the one or more application tables, at which location within the application table at least one data element corresponding to the subset of data categories is stored.

At step 806, access the at least one application table at the determined location and identify at least one data element of application table that fulfills the criterion. Step 805 or step 806 may involve building and executing a Structured Query Language command comprising a static part encoding a first portion of the criterion and a dynamic part encoding a second portion of the criterion different from the first portion of the criterion, wherein the second portion comprises the condition.

At step 807, output at least one data element that fulfills the criterion before the process 800 ends.

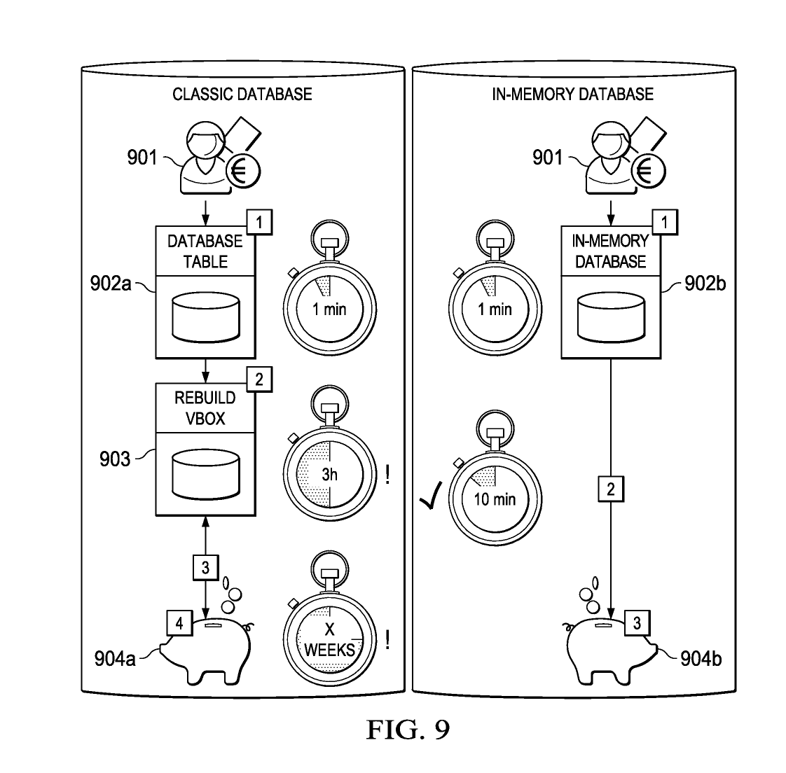

Turning now to FIG. 9. FIG. 9 summarizes the technical advantages and effects of the present application. FIG. 9 compares the processing steps (1, 2, 3, and 4) required in case of the conventional, classic database (left) using an index table with the in-memory database (right) omitting the index table. The index table for rebate processing was created to enable an access on rebate relevant invoices and to be able to perform rebate settlement in sufficient runtime. Rebate relevant data is stored in the application tables, but not as key fields. The selection of this data may require a huge runtime when processing mass data on a relational database (not supported by indices or key fields). Several joined selects may need to process full table scans on huge application tables, the resulting runtime would not be feasible for the business and the process would abort in many cases due to time outs.

In case of the convention database system using the index table, all potentially relevant data is written to the index table and thus a huge amount of data may be redundantly stored in the index table. The size of this index table can create technical problems for customers with big data volume (many invoices). The index table can become so huge that a considerable effort is required simply for administration of this table. In some cases the table may exceed several hundred gigabytes or event several terabytes of data. This may cause a very high total cost of ownership for the customer.

If a change of the native data or customizing changes of the criterion or condition occurs 901, a complete rebuild 903 (e.g., taking several hours) of the rebate index table (deletion of all data, re-creation of all data based on posted tables) may be required. All application tables in the system may need to be reconsidered 902a during this rebuild 903. For a high volume data base this rebuild may require a very high runtime (up to several days). Within the data processing, the data cannot be used since the data may not be up to date.

After an index rebuild 903 all open relevant agreements within the system may need to be recalculated 3, 904a and may be outputted 4, 904a in the end, since the data basis for the calculation could have been changed. This recalculation 904a processes all relevant data in the application table and retrieves them again. This may require a very long runtime (e.g., up to several weeks) during which the process does not have correctly calculated data.

These restrictions may no longer apply with in-memory technology (e.g., for column-based databases). With this technology data can be accessed 902b with sufficient runtime, even when the data is spread across several application tables and uses non-key fields or key fields for the selection. With the described invention the index table for data processing is fully replaced by a selection logic (e.g., a SQL logic and/or a mapping table) on application tables, thus preventing the issues caused by this index table. This means that the index table may be completely removed, no more redundant data is written for data processing purposes when the application table is posted to an operational division. The index table may no longer be required, reducing the required database and memory space (especially important for in memory databases). The omission of the index table may enable to embed the entire database in the in-memory database 170, 670 according to FIGS. 1-3, 6. This may enhance the processing speed and may reduce the runtime.

Changes of native data in the application tables may not require an index rebuild anymore. A change in the native data in the application data only needs to update the mapping table for a re-calculation 2, 904b of only the relevance agreements that are affected by the change (e.g., the recalculated results may be outputted 3, 904b). The mapping data, as mentioned above, stores much less data as the index table previously used and has still a commemoration where the data of the categories may be found in the application tables. These re-calculations 2, 904b may therefore be performed within minutes instead of weeks. The end user needs to perform less process steps and can perform data processing faster, more efficient and more flexible.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN). The computing system can include clients and servers. A client and server are generally remote from each other and typically interact through a communication network. The relationship of client and server arises by computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results. Accordingly, the above description of example implementations does not define or constrain this disclosure. Other changes, substitutions, and alterations are also possible without departing from the spirit and scope of this disclosure.

What is claimed is:

1. A system for accessing at least one of multiple data elements that are stored as non-key fields in one or more application tables, comprising:
an in-memory database storing the one or more application tables that store the multiple data elements as non-key fields; and
the system configured to execute operations comprising:
receiving a criterion; and
retrieving, without using an index table, at least one data element of the one or more application tables that fulfills the criterion.

2. The system of claim 1, wherein the index table is a table comprising a copy of at least one of the multiple data elements without a dynamic link to corresponding location of the data element in the one or more application tables so that the copy of the data element does not change upon a change of the corresponding original data element in the one or more application tables.

3. The system of claim 1, wherein the multiple data elements are grouped into one or more data categories, and wherein the criterion defines a subset of the one or more data categories and a condition data elements corresponding to the subset have to fulfill.

4. The system of claim 3, further comprising at least one mapping table that comprises one or more fields that provide a mapping between each of the one or more data categories and one or more locations, within the one or more application tables, of the data elements that correspond to the respective data category.

5. The system of claim 4, wherein the retrieving of at least one data element of the one or more application tables that fulfills the criterion comprises:
accessing the mapping table to determine, for at least one of the one or more application tables, at which location within the application table the at least one data element corresponding to the subset of data categories is stored.

6. The system of claim 4, wherein the mapping table does not comprise the data elements of the one or more application tables, and wherein the mapping table is configured to update its fields upon augmenting at least one of the application tables by an additional data element stored as non-key field at an additional location within the at least one of the application tables.

7. The system of claim 1, wherein the in-memory database is a column-based in-memory database.

8. The system of claim 1, wherein a non-key field of a table is a field that does not connect to a field of another table.

9. The system of claim 1, wherein an index table comprises combinations of data elements of the one or more application tables without memorizing at which location the data elements are located in the one or more application tables.

10. The system of claim 1, wherein the system is part of an online transaction processing system, wherein the one or more application tables originate from the online transaction processing system.

11. A method performed by a processor for accessing at least one of multiple data elements that are stored as non-key fields or key fields in one or more application tables, wherein the one or more application tables are stored in an in-memory database, the method comprising:
receiving a criterion; and
retrieving, without using an index table, at least one data element of the one or more application tables that fulfills the criterion.

12. The method of claim 11, wherein the in-memory database is a column-based in-memory database.

13. The method of claim 11, wherein the index table is a table comprising a copy of at least one of the multiple data elements without a dynamic link to corresponding location of the data element in the one or more application tables so that the copy of the data element does not change upon a change of the corresponding original data element in the one or more application tables.

14. The method of claim 11, wherein the multiple data elements are grouped into one or more data categories, and wherein the criterion defines a subset of the one or more data categories and a condition data elements corresponding to the subset have to fulfill.

15. The method of claim 14, wherein at least one mapping table comprises one or more fields that provide a mapping between each of the one or more data categories and one or more locations, within the one or more application tables, of the data elements that correspond to the respective data category, and
wherein the retrieving of at least one data element of the one or more application tables that fulfills the criterion comprises:
accessing the mapping table to determine, for at least one of the one or more application tables, at which location within the application table the at least one data element corresponding to the subset of data categories is stored.

16. The method of claim 14, wherein the retrieving of at least one data element of the one or more application tables that fulfills the criterion comprises:
building and executing a Structured Query Language command comprising a static part encoding a first portion of the criterion and a dynamic part encoding a second portion of the criterion different from the first portion of the criterion, wherein the second portion comprises the condition.

17. The method of claim 11, further comprising:
updating the mapping table upon augmenting at least one of the application tables by an additional data element stored as non-key field or key field at an additional location within the at least one of the application tables.

18. A computer-readable medium having computer-executable instructions stored thereon that, when executed by a processor, cause the processor to perform operations for accessing at least one of multiple data elements that are stored as non-key fields or key fields in one or more application tables, wherein the one or more application tables are stored in an in-memory database, the operations comprising:
receiving a criterion; and
retrieving, without using an index table, at least one data element of the one or more application tables that fulfills the criterion.

19. The computer-readable medium of claim 18, wherein the in-memory database is a column-based in-memory database.

20. The computer-readable medium of claim 18, wherein the index table is a table comprising a copy of at least one of the multiple data elements without a dynamic link to corresponding location of the data element in the one or more application tables so that the copy of the data element does not change upon a change of the corresponding original data element in the one or more application tables.

21. The computer-readable medium of claim 18, wherein the multiple data elements are grouped into one or more data categories, and wherein the criterion defines a subset of the one or more data categories and a condition data elements corresponding to the subset have to fulfill.

22. The computer-readable medium of claim 21, wherein at least one mapping table comprises one or more fields that provide a mapping between each of the one or more data categories and one or more locations, within the one or more application tables, of the data elements that correspond to the respective data category, and wherein the retrieving of at least one data element of the one or more application tables that fulfills the criterion comprises:
accessing the mapping table to determine, for at least one of the one or more application tables, at which location within the application table the at least one data element corresponding to the subset of data categories is stored.

23. A system for accessing at least one of multiple data elements that are stored as non-key fields in one or more application tables, the system comprising:
an in-memory database storing the one or more application tables that store the multiple data elements as non-key fields, wherein the multiple data elements are grouped into one or more data categories, and wherein the criterion defines a subset of the one or more data categories and a condition data elements corresponding to the subset have to fulfill;
at least one mapping table comprising one or more fields that provide a mapping between each of the one or more data categories and one or more locations, within the one or more application tables, of the data elements that correspond to the respective data category; and
the system configured to execute operations comprising:
receiving a criterion;
retrieving at least one data element of the one or more application tables that fulfills the criterion, wherein the retrieving of at least one data element of the one or more application tables that fulfills the criterion comprises:
accessing the mapping table to determine, for at least one of the one or more application tables, at which location within the application table the at least one data element corresponding to the subset of data categories is stored.

24. The system of claim 23, wherein the at least one data element of the one or more application tables that fulfills the criterion is retrieved without using an index table, wherein the index table is a table comprising a copy of at least one of the multiple data elements without a dynamic link to corresponding location of the data element in the one or more application tables so that the copy of the data element does not change upon a change of the corresponding original data element in the one or more application tables.
